(19) United States
(12) Patent Application Publication
(10) Pub. No.: US 2020/0159769 A1
(43) Pub. Date: May 21, 2020

(54) METHODS, SYSTEMS, AND MEDIA FOR COMBINING CLASSIFIER SCORES OF A HIERARCHICAL SET OF ENTITIES

(71) Applicant: Google LLC, Mountain View, CA (US)

(72) Inventors: Luca Chiarandini, Zurich (CH); Aviv Reznik, Zurich (CH)

(21) Appl. No.: 16/685,665

(22) Filed: Nov. 15, 2019

Related U.S. Application Data
(60) Provisional application No. 62/769,887, filed on Nov. 20, 2018.

(51) Int. Cl. G06F 16/75; G06F 16/732; G06F 16/74; G06F 16/738

(52) U.S. Cl. CPC G06F 16/75; G06F 16/738; G06F 16/74; G06F 16/732

(57) ABSTRACT

Methods, systems, and media for combining classifier scores of a hierarchical set of entities are provided. In accordance with some embodiments of the disclosed subject matter, a method for generating classifier scores of a hierarchical set of entities is provided, the method comprising: determining a first plurality of scores associated with a media content item; determining a second plurality of scores associated with a first ancestor entity of the media content item; calculating an aggregate score of the media content item based on the first plurality of scores and the second plurality of scores; determining whether the media content item is to be demoted based on the aggregate score; and in response to determining that the media content item is to be demoted based on the aggregate score, causing the media content item to be demoted.

### CROSS REFERENCE TO RELATED APPLICATION

This application claims the benefit of U.S. Provisional Application No. 62/769,887, filed Nov. 20, 2018, which is hereby incorporated by reference herein in its entirety.

### TECHNICAL FIELD

The disclosed subject matter relates to methods, systems, and media for combining classifier scores of a hierarchical set of entities.

### BACKGROUND

Media content platforms have become the primary mechanism by which users discover and share digital media content. While many user-generated channels on a media content platform contain original, non-abusive content, there are also user channels that contain abusive content, such as misleading, repetitive, racy, pornographic, infringing, and/or “clickbait” content, to target unsuspecting users. Proliferation of abusive content on media content platforms can increase the computation time and associated resources required by computing devices associated with such media content platforms to provide digital media content (e.g., increase the amount of memory, increase processing time, etc.), while also degrading the user experience.

Existing solutions attempt to address this problem by identifying abusive user channels. However, these existing solutions cannot capture sparse abuse by a user channel. For example, many user channels predominantly contain non-abusive content, but also contain one abusive playlist including full episodes of a television program. Existing solutions would identify these user channels as being fully abusive, which would be inaccurate because the channels substantially contain non-abusive content.

Accordingly, it is desirable to provide new methods, systems, and media for combining classifier scores of a hierarchical set of entities.

### SUMMARY

Methods, systems, and media for combining classifier scores of a hierarchical set of entities are provided.

In accordance with some embodiments of the disclosed subject matter, a method for generating classifier scores of a hierarchical set of entities is provided, the method comprising: determining a first plurality of scores associated with a media content item; determining a second plurality of scores associated with a first ancestor entity of the media content item; calculating an aggregate score of the media content item based on the first plurality of scores and the second plurality of scores; determining whether the media content item is to be demoted based on the aggregate score; and in response to determining that the media content item is to be demoted based on the aggregate score, causing the media content item to be demoted.

In some embodiments, the method further comprises determining a third plurality of scores that is associated with a second ancestor entity of the media content item, wherein calculating the aggregate score of the media content item comprises calculating the aggregate score based on the first plurality of scores, the second plurality of scores, and the third plurality of scores.

In some embodiments, the media content item corresponds to a video item, and wherein the first ancestor entity corresponds to a playlist that includes the video item or a user channel that uploaded the video item.

In some embodiments, the first plurality of scores comprises a classifier score that indicates a quality of the media content item and a protection score that indicates an amount of protection from demotion provided to the media content item.

In some embodiments, the method further comprises storing the first plurality of scores in a storage device, wherein the classifier score and the protection score are stored in different locations in the storage device.

In some embodiments, the method further comprises: receiving a search query; generating a plurality of search results in response to the search query, wherein one of the plurality of search results corresponds to the media content item; and causing at least a portion of the plurality of search results to be presented based on the demotion.

In accordance with some embodiments of the disclosed subject matter, a system for generating classifier scores of a hierarchical set of entities is provided, the system comprising: a hardware processor that is configured to: determine a first plurality of scores associated with a media content item; determine a second plurality of scores associated with a first ancestor entity of the media content item; calculate an aggregate score of the media content item based on the first plurality of scores and the second plurality of scores; determine whether the media content item is to be demoted based on the aggregate score; and in response to determining that the media content item is to be demoted based on the aggregate score, cause the media content item to be demoted.

In accordance with some embodiments of the disclosed subject matter, a non-transitory computer-readable medium containing computer-executable instructions that, when executed by a processor, cause the processor to perform a method for generating classifier scores of a hierarchical set of entities is provided, the method comprising: determining a first plurality of scores associated with a media content item; determining a second plurality of scores associated with a first ancestor entity of the media content item; calculating an aggregate score of the media content item based on the first plurality of scores and the second plurality of scores; determining whether the media content item is to be demoted based on the aggregate score; and in response to determining that the media content item is to be demoted based on the aggregate score, causing the media content item to be demoted.

In accordance with some embodiments of the disclosed subject matter, a system for generating classifier scores of a hierarchical set of entities is provided is provided, the system comprising: means for determining a first plurality of scores associated with a media content item; means for determining a second plurality of scores associated with a first ancestor entity of the media content item; means for calculating an aggregate score of the media content item based on the first plurality of scores and the second plurality of scores; determining whether the media content item is to be demoted based on the aggregate score; and means for causing the media content item to be demoted in response to determining that the media content item is to be demoted based on the aggregate score.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a process for combining classifier scores of a hierarchical set of entities in accordance with some embodiments of the disclosed subject matter.

FIG. 2 shows an example of a diagram of a hierarchical set of entities in accordance with some embodiments of the disclosed subject matter.

FIG. 3 shows an example of a diagram for calculating an aggregate score of an entity in accordance with some embodiments of the disclosed subject matter.

FIG. 4 shows an example of a process for demoting an entity in accordance with some embodiments of the disclosed subject matter.

FIG. 5 shows an example of a system for ingesting entity scores in accordance with some embodiments of the disclosed subject matter.

FIG. 6 shows an example notification message for indicating one or more entity scores in accordance with some embodiments of the disclosed subject matter.

FIG. 7 shows an example of a process for storing entity scores in accordance with some embodiments of the disclosed subject matter.

FIG. 8 shows an illustrative system suitable for combining classifier scores of a hierarchical set of entities in accordance with some embodiments of the disclosed subject matter.

FIG. 9 shows a detailed example of hardware that can be used in a server and/or a user device of FIG. 8 in accordance with some embodiments of the disclosed subject matter.

### DETAILED DESCRIPTION

In accordance with various embodiments, mechanisms (which can include methods, systems, and media) for combining classifier scores of a hierarchical set of entities are provided.

In some embodiments, the mechanisms described herein can be used to store and combine multiple classifier scores defined on a hierarchical set of entities (e.g., a video, a playlist, a user channel, etc.). For example, in some embodiments, the mechanisms described herein can determine classifier scores of an entity and classifier scores of one or more ancestors with which the entity has a hierarchical relationship. The mechanisms described herein can then combine the classifier scores to yield an aggregate score for the entity in some embodiments. Accordingly, in some embodiments, the mechanisms described herein can be used to classify entities at a mixed granularity.

In some embodiments, the mechanisms described herein can also combine protection scores defined on the hierarchical set of entities. For example, in some embodiments, the mechanisms described herein can combine the classifier scores with protection scores of an entity and/or of one or more ancestors of the entity to generate the aggregate score of the entity. In some embodiments, a protection score can increase the lower bound of the aggregate score, thereby providing an approach to whitelist a particular set of entities. Accordingly, in some embodiments, the mechanisms described herein can be used to protect a valued set of entities from being demoted.

In some embodiments, the mechanisms described herein can ingest entity scores in real time. For example, in some embodiments, the mechanisms described herein can receive notification messages indicating new classifier scores and/or new protection scores and then store the scores in a storage device. In some embodiments, the mechanisms described herein can store each classifier score and/or each protection score of an entity in an independent location. In some embodiments, the mechanisms described herein can store the most recent version of a score. For example, in some embodiments, the mechanisms described herein can overwrite a score of an entity with an updated version of the score of the entity. Accordingly, in some embodiments, the mechanisms described herein can improve the efficiency of ingestion and decrease latency in providing scores to requestors.

In some embodiments, the mechanisms described herein can demote one or more search results based on the aggregate score of an entity. For example, in some embodiments, the mechanisms described herein can determine an entity having an aggregate score that is below a predetermined threshold and can cause one or more media content items (e.g., playlists, videos, and/or any other suitable media content item) associated with the entity to be demoted in a set of search results. In a more particular example, in some embodiments, the mechanisms described herein can decrease a rank in which a demoted media content item is presented in an ordered list of search results or inhibit the demoted media content item from being presented in the list of search results. Accordingly, in some embodiments, the mechanisms described herein can be used to mitigate abuse, such as providing abusive media content items, on media content platforms.

In some embodiments, the mechanism described herein can improve media content classification technology and search engine technology. For example, in some embodiments, the mechanisms described herein can improve on existing solutions by leveraging a combination of a generalized score inherited from a parent entity and a specific score assigned to a child entity to more accurately and flexibly classify entities. Accordingly, in some embodiments, the mechanisms described herein can more appropriately perform an action against a user-generated channel associated with a user account that is deemed to be abusive.

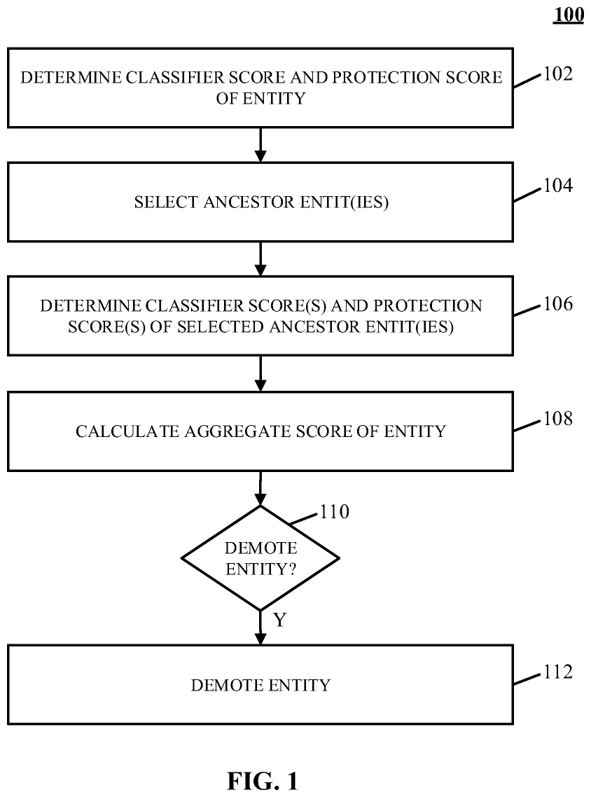

These and other features for combining classifier scores of a hierarchical set of entities are described further in connection with FIGS. 1-9.

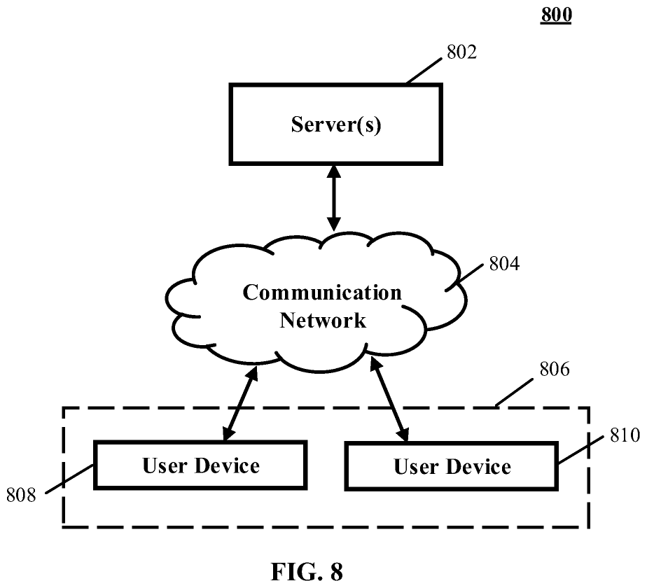

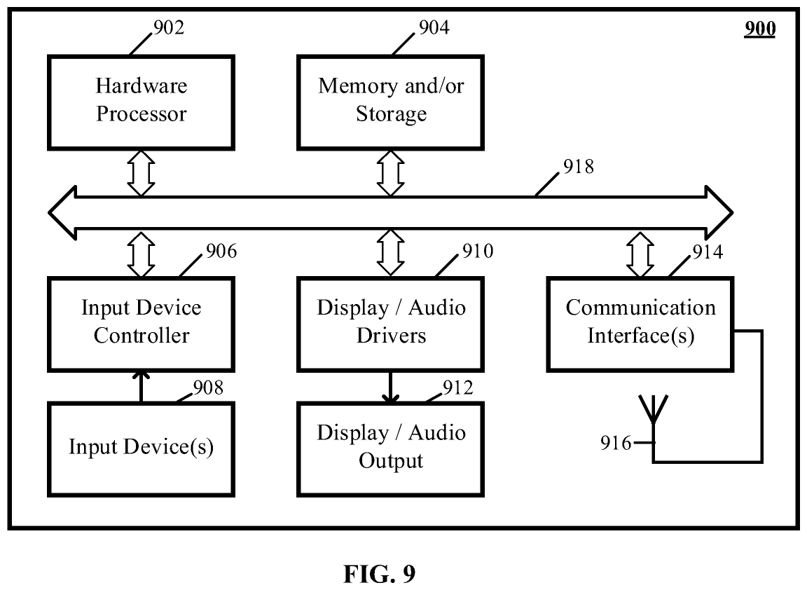

Turning to FIG. 1, an illustrative example 100 of a process for combining classifier scores of a hierarchical set of entities in accordance with some embodiments of the disclosed subject matter is shown. As illustrated, blocks of process 100 can be executed by one or more servers, as shown in and described below in connection with FIGS. 8 and 9, and/or any other suitable computing device(s).

At 102, process 100 can determine a set of scores associated with an entity. In some embodiments, an entity can include any suitable type of entity. For example, in some embodiments, an entity can include a media content item of a media content platform, such as a video content item (e.g., a video clip, an episode of a show, a movie, and/or any other suitable video content item), an audio content item (e.g., an audio clip, a podcast, music, an audiobook, and/or any other suitable audio content item), an image, and/or any other suitable media content item. In another example, an entity can include a playlist comprising one or more media content items. It is noted that, in some embodiments, a playlist itself can be considered as a media content item. In yet another example, in some embodiments, an entity can include a user of the media content platform. In particular, an entity can include a user channel that represents a user account on the media content platform in some embodiments.

In some embodiments, the set of scores can include one or more classifier scores associated with the entity. In some embodiments, a classifier score can include a value that represents a quality of an entity based on a characteristic of the entity. For example, in some embodiments, a classifier score can include a value representing whether a video is pornographic. In another example, in some embodiments, a classifier score can include a value representing an extent to which a video is considered “spam” content. That is, in some embodiments, a spam video can include unrelated, misleading, repetitive, and/or “clickbait” content to target unsuspecting users. It should be noted that a classifier score can represent any suitable characteristic of an entity. In some embodiments, an entity can be demoted based on its associated classifier scores. For example, in some embodiments, an entity can be demoted if its classifier score(s) are below a suitable threshold.

Additionally, in some embodiments, the set of scores can include one or more protection scores associated with the entity. In some embodiments, a protection score can be combined with the classifier score(s) and can include a value that represents an extent to which an entity is whitelisted or otherwise protected from content demotion. For example, in some embodiments, a user channel having a relatively high number of subscribers (e.g., a user channel having greater than 15,000 subscribers) can be associated with a protection score that increases a lower bound on the combined score for the entity, thereby providing an amount of protection to the user channel from content demotion or other actions. In some embodiments, the set of scores can include any other suitable score.

In some embodiments, each of the scores can be any suitable type of value (e.g., an integer, a decimal, etc.) and can follow any suitable type of scoring scheme (e.g., bucketed, continuous, etc.). In some embodiments, each of the scores can vary monotonically such that a larger value represents a relatively “good” entity.

In some embodiments, process 100 can determine the set of scores associated with the entity in any suitable manner. For example, in some embodiments, process 100 can retrieve the scores from one or more local databases. Additionally or alternatively, in some embodiments, process 100 can receive the scores from one or more remote sources, such as a remote server. In another example, in some embodiments, if process 100 cannot determine the set of scores (e.g., the scores do not exist, there is insufficient information for calculating one or more scores, etc.), then process 100 can determine a set of default values as the set of scores.

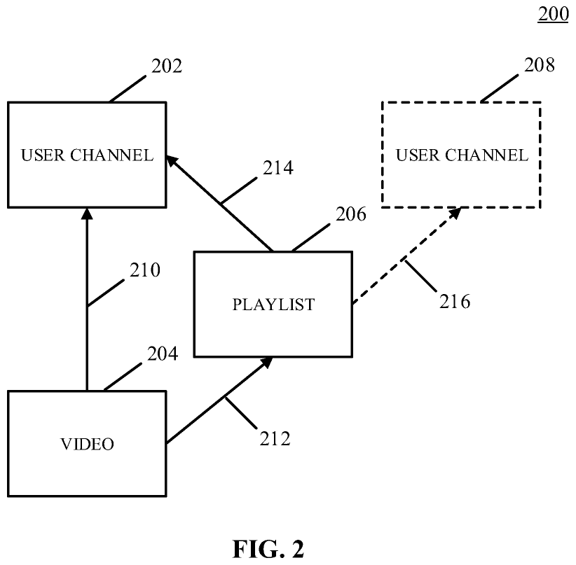

In some embodiments, process 100 can select one or more ancestor entities of the entity of which respective sets of scores are to be combined with the set of scores associated with the entity at 104. In some embodiments, an ancestor entity can refer to a parent entity and/or a grandparent entity. That is, in some embodiments, multiple entities can be hierarchically related such that each entity can form a parent/child relationship or a grandparent/grandchild relationship with another entity, such as in the hierarchy shown and described in connection with FIG. 2.

Turning to FIG. 2, an illustrative example 200 of a diagram of a hierarchical set of entities in accordance with some embodiments of the disclosed subject matter is shown. As illustrated, diagram 200 can include a user channel 202, a video 204, a playlist 206, and a user channel 208.

In some embodiments, when user channel 202 that is associated with a user account uploads video 204, user channel 202 and video 204 can form a parent/child relationship 210. In particular, in some embodiments, user channel 202 can be a parent (entity) of video 204 and video 204 can be a child (entity) of user channel 202 according to parent/child relationship 210. Similarly, in some embodiments, when playlist 206 includes video 204, playlist 206 and video 204 can form a parent/child relationship 212, where playlist 206 can be a parent of video 204 and video 204 can be a child of playlist 206.

In some embodiments, when user channel 202 that is associated with a user account creates playlist 206, user channel 202 and playlist 206 can form a parent/child relationship 214, where user channel 202 can be a parent of playlist 206 and playlist 206 can be a child of user channel 202. Additionally, in some embodiments, when user channel 202 creates playlist 206 that includes video 204, user channel 202 and video 204 can also create a grandparent/grandchild relationship by way of parent/child relationship 210 and parent/child relationship 212. In other words, user channel 202 can also be a grandparent (entity) of video 204 and video 204 can also be a grandchild (entity) of user channel 202 when user channel 202 creates playlist 206 that includes video 204 in some embodiments.

Alternatively, in some embodiments, when user channel 208 creates playlist 206, user channel 208 and playlist can form a parent/child relationship 216. Furthermore, when user channel 208 creates playlist 206 that includes video 204, user channel 208 and video 204 can form a grandparent/grandchild relationship by way of parent/child relationship 212 and parent/child relationship 216 in some embodiments.

Turning back to FIG. 1, in some embodiments, process 100 can select one or more ancestors of the entity in any suitable manner. For example, in some embodiments, for a given video, process 100 can select the user channel that uploaded the given video. In another example, in some embodiments, for a given video included in a playlist, process 100 can select the user channel that uploaded the given video, the playlist to which the given video is included, the user channel that created the playlist, and/or any other suitable ancestor entity.

At 106, process 100 can determine respective sets of scores associated with each selected ancestor. In some embodiments, each set of scores associated with an ancestor can include one or more classifier scores associated with the ancestor and/or one or more protection scores associated with the ancestor. In some embodiments, process 100 can determine the sets of scores in any suitable manner. For example, in some embodiments, process 100 can retrieve the scores from one or more local databases. Additionally or alternatively, in some embodiments, process 100 can receive the scores from one or more remote sources, such as a remote server. In another example, in some embodiments, if process 100 cannot determine the scores (e.g., the scores do not exist, etc.), then process 100 can determine a set of default values as the scores.

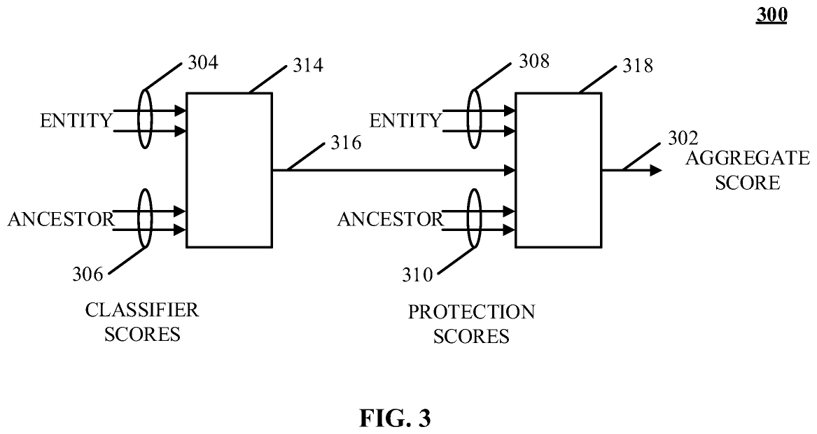

At 108, process 100 can calculate an aggregate score of the entity. In some embodiments, process 100 can calculate the aggregate score based on the determined set of scores associated with the entity, the determined set(s) of scores associated with any selected ancestor of the entity, and/or any other suitable basis. For example, in some embodiments, process 100 can calculate an aggregate score using any suitable function that maps classifier scores and protection scores to an aggregate score. In a more particular example, in some embodiments, process 100 can combine the classifier scores of the entity and the selected ancestor(s), which can then be combined with the protection scores of the entity and the selected ancestor(s) to yield the aggregate score of the entity. In some embodiments, process 100 can calculate an aggregate score of the entity in any suitable manner, such as in the manner shown and described in connection with FIG. 3.

Turning to FIG. 3, an illustrative example 300 of a diagram for calculating an aggregate score of an entity in accordance with some embodiments of the disclosed subject matter is shown. As illustrated, blocks of diagram 300 can be executed by one or more servers, as shown in and described below in connection with FIGS. 8 and 9, and/or any other suitable computing device(s).

In some embodiments, an aggregate score 302 of an entity can be calculated by combining classifier scores 304 of the entity, classifier scores 306 of one or more ancestor entities, protection scores 308 of the entity, and/or protection scores 310 of the one or more ancestor entities. In particular, in some embodiments, entity classifier scores 304 and ancestor classifier scores 306 can be combined at operation 314. The output 316 of operation 314 can then be combined with entity protection scores 308 and ancestor protection scores 310 at operation 318 in some embodiments. In some embodiments, the aggregate score 302 is the output of operation 318.

In some embodiments, operation 314 and operation 318 can be any suitable operation used to combine their respective inputs (e.g., entity classifier scores 304, ancestor classifier scores 306, entity protection scores 308, ancestor protection scores 310, and/or output 316) and yield their respective outputs (e.g., output 316 and/or aggregate score 302). In some embodiments, operation 314 and/or operation 318 can apply any suitable weighting scheme. For example, in some embodiments, operation 314 and/or operation 318 can assign a weight to each input. It is noted that, in some embodiments, two inputs (e.g., a first entity classifier score and a second entity classifier score) can be assigned the same or different weights.

Although two entity classifier scores 304, two ancestor classifier scores 306, two entity protection scores 308, and two ancestor protection scores 310 are shown in FIG. 3 to avoid over-complicating the figure, any suitable number of entity classifier scores, ancestor classifier scores, entity protection scores, and/or ancestor protection scores can be used in some embodiments.

Turning back to FIG. 1, in some embodiments, process 100 can determine whether the entity is to be demoted based on the calculated aggregate score of the entity at 110. In some embodiments, process 100 can determine whether the entity is to be demoted in any suitable manner. For example, in some embodiments, process 100 can determine whether the calculated aggregate score is below a predetermined threshold.

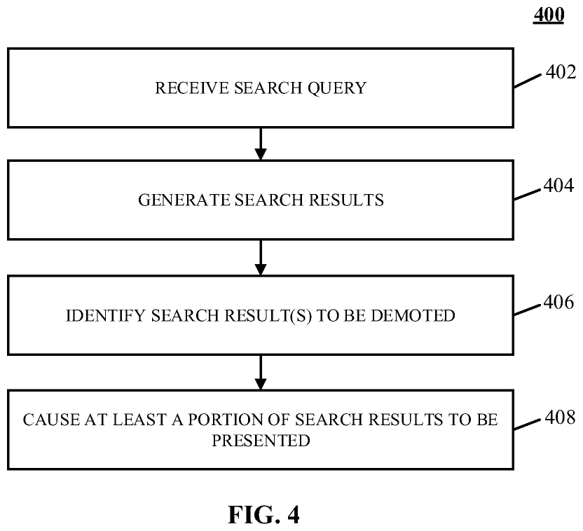

At 112, process 100 can demote the entity in response to determining that the entity is to be demoted at 110. In some embodiments, process 100 can demote the entity in any suitable manner. For example, in some embodiments, process 100 can add the entity to a blacklist. Additionally or alternatively, in some embodiments, process 100 can lower a rank in which the entity (or children of the entity) is presented in an ordered list of search results, prevent the entity (or children of the entity) from being presented in a list of search results, prevent monetization of the entity (or of children of the entity) associated with playback of the entity, and/or any other suitable action. In another example, in some embodiments, process 100 can demote the entity in the manner shown and described in connection with FIG. 4.

It is noted that, in some embodiments, blocks of process 100 can be performed in response to the detection of any suitable condition. For example, in some embodiments, blocks of process 100 can be performed in response to receiving a search query, generating a plurality of search results, and/or identifying search results to be demoted. In another example, in some embodiments, blocks of process 100 can be performed in response to receiving a command to recalculate an aggregate score for each entity. Blocks of process 100 can be performed iteratively at a predetermined frequency (e.g., daily) in some embodiments.

Turning to FIG. 4, an example 400 of a process for demoting an entity in accordance with some embodiments of the disclosed subject matter is shown. As illustrated, blocks of process 400 can be executed by one or more servers, as shown in and described below in connection with FIGS. 8 and 9, and/or any other suitable computing device(s).

At 402, process 400 can receive a search query. For example, in some embodiments, process 400 can receive a search query for one or more media content items from a user device. In some embodiments, a search query can include one or more search terms and/or any other suitable information.

At 404, process 400 can generate search results in response to receiving the search query. For example, in some embodiments, process 500 can generate search results including one or more media content items associated with the search term(s) included in the search query and/or any other suitable information. In some embodiments, each search result can correspond to a different media content item. For example, in some embodiments, a media content item can include a video content item (e.g., a video clip, an episode of a show, a movie, and/or any other suitable video content item), an audio content item (e.g., an audio clip, a podcast, music, an audiobook, and/or any other suitable audio content item), a playlist (e.g., a video playlist, an audio playlist, a mixed media playlist, and/or any other suitable playlist), an image, and/or any other suitable media content item.

At 406, prior to presenting the search results, process 400 can identify one or more search results to be demoted. For example, in some embodiments, process 400 can determine whether any media content items included in the search results is associated with an entity determined to be demoted, such as in block 110 of FIG. 1. For example, in some embodiments process 400 can identify one or more search results that are associated with an entity (e.g., a user channel, a playlist, a media content item, etc.) that has an aggregate score below a predetermined threshold. In a more particular example, for a video that has an aggregate score below the threshold, process 400 can identify a search result corresponding to the video. In another more particular example, for a user channel that has an aggregate score below the threshold, process 400 can identify multiple search results corresponding to videos and/or playlists of the user channel.

At 408, process 400 can demote the identified search result(s). For example, in some embodiments, process 400 can cause at least a portion of the generated search results to be presented such that one or more demoted search results are prevented from being presented. Additionally or alternatively, in some embodiments, process 400 can cause at least a portion of the generated search results to be presented such that one or more demoted search results are presented at a lower rank than originally generated. In some embodiments, process 400 can cause the search results to be presented on the user device that sent the search query. In some embodiments, process 400 can demote the identified search result(s) in any suitable manner.

In some embodiments, process 400 can present an indication as to which search results have been demoted. For example, a user interface that presents the portion of search results can include a visual indicator or other user interface element that indicates a search result has been demoted, a search result is associated with an entity that has been demoted, a search result is associated with an aggregated score less than a particular value, etc.

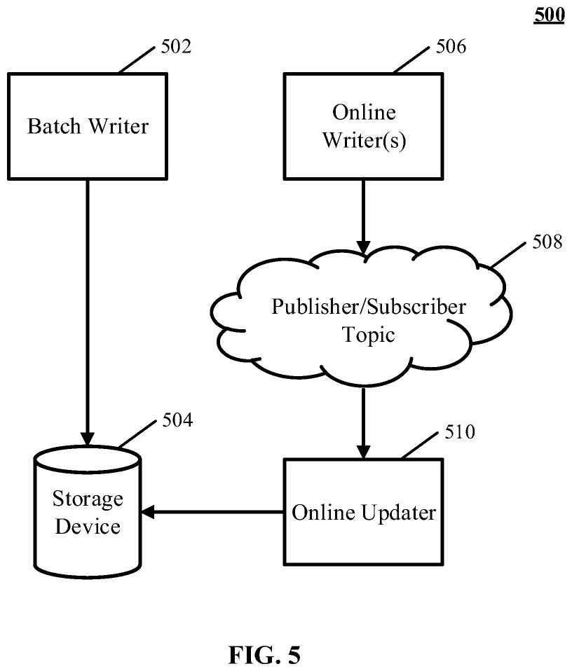

Turning to FIG. 5, an illustrative example 500 of system for ingesting entity scores in accordance with some embodiments of the disclosed subject matter is shown. As illustrated, system 500 can include a batch writer 502, a storage device 504, an online writer 506, a publisher/subscriber topic 508, and/or an online updater 510. It is noted that, in some embodiments, elements 502, 504, 506, 508, and/or 510 can be implemented by one or more servers, as shown in and described below in connection with FIGS. 8 and 9, and/or any other suitable computing device(s).

In some embodiments, entity scores can be ingested using batch ingestion and/or online ingestion. For example, in some embodiments, batch writer 502 can write entity scores directly to storage device 504 using batch ingestion. In another example, in some embodiments, online ingestion of entity scores into storage device 504 can be accomplished through online writer(s) 506, publisher/subscriber topic 508, and online updater 510.

In some embodiments, storage device 504 can store each of the entity scores in an independent location. Additionally, in some embodiments, storage device 504 can store the most recent version of each entity score. For example, in some embodiments, storage 504 can replace a classifier score for a given entity with an updated classifier score for the given entity.

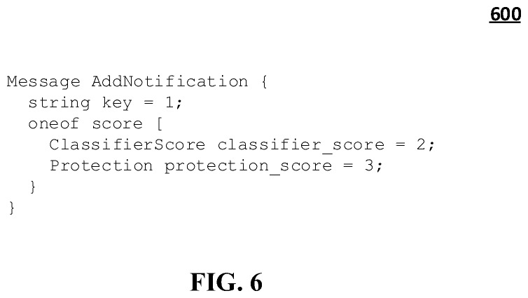

In some embodiments, one or more online writers 506 can publish entity scores in real time to publisher/subscriber topic 508. In some embodiments, online writer 506 can publish entity scores in any suitable manner. For example, in some embodiments, online writer 506 can send a notification message indicating one or more entity scores. In a more particular example, in some embodiments, online writer 506 can send a notification message 600 for indicating one or more entity scores, as shown in connection with FIG. 6.

In some embodiments, online writer 506 can send a notification message including at most one entity score. In some embodiments, a notification message including at most one entity score can easily be monitored and/or filtered to whitelist particular classifier scores (e.g., using keywords) and/or publishers. In some embodiments, a notification message including at most one entity score can also be fault tolerant because the method in which one score is generated or published does not affect another score.

Alternatively, in some embodiments, online writer 506 can send a notification message including multiple entity scores. In some embodiments, a notification message including multiple scores can be more convenient and/or efficient because a publisher can produce multiple scores at substantially the same time and publish a single notification message.

In some embodiments, publisher/subscriber topic 508 can receive notification messages from one or more online writers 506 and can deliver the messages to all interested subscribers. For example, in some embodiments, publisher/subscriber topic 508 can deliver notification messages to online updater 508 for storage in storage device 504.

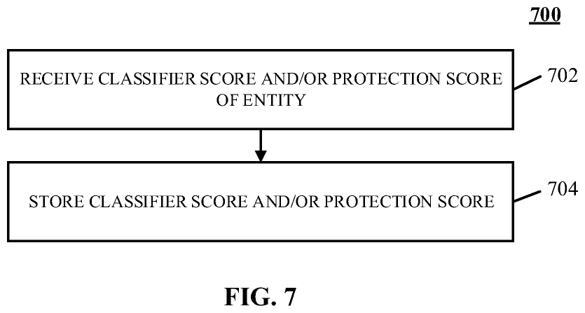

In some embodiments, online updater 510 can write newly ingested scores from publisher/subscriber topic 508 to storage device 504 in real time. In some embodiments, online updater 510 can store entity scores in 504 in any suitable manner, such as in the manner shown and described in connection with FIG. 7.

Turning to FIG. 7, an illustrative example 700 of a process for storing entity scores in accordance with some embodiments of the disclosed subject matter is shown. As illustrated, blocks of process 700 can be executed by one or more servers, as shown in and described below in connection with FIGS. 8 and 9, and/or any other suitable computing device(s).

At 702, process 700 can receive one or more entity scores. For example, in some embodiments, process 700 can receive one or more classifier scores and/or one or more protection scores associated with an entity. In some embodiments, process 700 can receive the entity scores in any suitable manner. For example, in some embodiments, process 700 can receive the entity scores from one or more classifiers, one or more publishers, a publisher/subscriber topic, and/or any other suitable source(s). In a more particular example, in some embodiments, process 700 can receive the scores from one or more online writers that publish entity scores in real time via a publisher/subscriber topic.

In some embodiments, process 700 can receive a notification message from a publisher indicating one or more entity scores. In some embodiments, the notification message can pertain to a single entity score (e.g., one classifier score or one protection score). Alternatively, in some embodiments, the notification message can pertain to multiple entity scores. In some embodiments, process 700 can bundle messages from the same publisher and bundle writes to the storage device.

At 704, process 700 can store the received entity scores in a storage device. In some embodiments, process 700 can store the scores in any suitable manner. For example, in some embodiments, process 700 can store the scores in one or more local databases. Additionally or alternatively, in some embodiments, process 500 can store the scores in one or more remote locations, such as a remote server. In some embodiments, process 700 can store each score (e.g., each classifier score of an entity, each protection score of an entity, etc.) in an independent location in storage. Furthermore, in some embodiments, process 700 can keep the most recent version of a score. For example, in some embodiments, process 700 can overwrite a classifier score of a given entity with an updated version of the classifier score of the given entity.

Turning to FIG. 8, an example 800 of a system for combining classifier scores of a hierarchical set of entities in accordance with some embodiments of the disclosed subject matter is shown. As illustrated, system 800 can include a server(s) 802, a communication network 804, and/or one or more user devices 806, such as user device 808 and user device 810.

Server(s) 802 can be any suitable server for storing information, data, programs, and/or any other suitable type of content for combining classifier scores of a hierarchical set of entities. In some embodiments, server(s) 802 can perform any suitable function(s), such as determining classifier scores and/or protection scores, selecting ancestor entities, calculating aggregate scores, determining whether to demote an entity, demoting entities, receiving search queries, generating search results, identified search results to be demoted, causing search results to be presented, receiving classifier scores and/or protection scores, and/or storing classifier scores and/or protection scores as described above in connection with FIGS. 1-7.

Communication network 804 can be any suitable combination of one or more wired and/or wireless networks in some embodiments. For example, communication network 604 can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. In some embodiments, communication network 804 can be linked via one or more communications links to server(s) 802 and/or user device(s) 806. The communications links can be any communications links suitable for communicating data among user device(s) 806 and server(s) 802, such as network links, dial-up links, wireless links, hard-wired links, any other suitable communications links, or any suitable combination of such links.

User device(s) 806 can include any one or more user devices. For example, in some embodiments, user device(s) 806 can include a television, speakers, a mobile phone, a tablet computer, a desktop computer, a laptop computer, a vehicle entertainment system, a wearable computer, and/or any other suitable type of user device. In some embodiments, user device(s) 806 can perform any suitable function(s), such as sending a search query and/or presenting search results, as described above in connection with FIGS. 1 and 4.

Although server(s) 802 is illustrated as one device, the functions performed by server(s) 802 can be performed using any suitable number of devices in some embodiments. For example, in some embodiments, multiple devices can be used to implement the functions performed by server(s) 802.

Although two user devices 808 and 810 are shown in FIG. 8 to avoid over-complicating the figure, any suitable number of user devices, and/or any suitable types of user devices, can be used in some embodiments.

Server(s) 802 and user device(s) 806 can be implemented using any suitable hardware in some embodiments. For example, in some embodiments, devices 802 and 806 can be implemented using any suitable general-purpose computer or special-purpose computer. For example, a mobile phone may be implemented using a special-purpose computer. Any such general-purpose computer or special-purpose computer can include any suitable hardware. For example, as illustrated in example hardware 900 of FIG. 9, such hardware can include hardware processor 902, memory and/or storage 904, an input device controller 906, an input device 908, display/audio drivers 910, display and audio output circuitry 912, communication interface(s) 914, an antenna 916, and a bus 918.

Hardware processor 902 can include any suitable hardware processor, such as a microprocessor, a micro-controller, digital signal processor(s), dedicated logic, and/or any other suitable circuitry for controlling the functioning of a general-purpose computer or a special-purpose computer in some embodiments. In some embodiments, hardware processor 902 can be controlled by a server program stored in memory and/or storage 904. For example, in some embodiments, the server program can cause hardware processor 902 to determine classifier scores and/or protection scores, select ancestor entities, calculate aggregate scores, determining whether to demote an entity, demote entities, receive search queries, generate search results, identify search results to be demoted, cause search results to be presented, receive classifier scores and/or protection scores, and/or store classifier scores and/or protection scores as described above in connection with FIGS. 1-7, and/or perform any other suitable functions.

Memory and/or storage 904 can be any suitable memory and/or storage for storing programs, data, and/or any other suitable information in some embodiments. For example, memory and/or storage 904 can include random access memory, read-only memory, flash memory, hard disk storage, optical media, and/or any other suitable memory.

Input device controller 906 can be any suitable circuitry for controlling and receiving input from one or more input devices 908 in some embodiments. For example, input device controller 906 can be circuitry for receiving input from a touchscreen, from a keyboard, from one or more buttons, from a voice recognition circuit, from a microphone, from a camera, from an optical sensor, from an accelerometer, from a temperature sensor, from a near field sensor, from a pressure sensor, from an encoder, and/or any other type of input device.

Display/audio drivers 910 can be any suitable circuitry for controlling and driving output to one or more display/audio output devices 912 in some embodiments. For example, display/audio drivers 910 can be circuitry for driving a touchscreen, a flat-panel display, a cathode ray tube display, a projector, a speaker or speakers, and/or any other suitable display and/or presentation devices.

Communication interface(s) 914 can be any suitable circuitry for interfacing with one or more communication networks (e.g., communication network 804). For example, interface(s) 914 can include network interface card circuitry, wireless communication circuitry, and/or any other suitable type of communication network circuitry.

Antenna 916 can be any suitable one or more antennas for wirelessly communicating with a communication network (e.g., communication network 804) in some embodiments. In some embodiments, antenna 916 can be omitted.

Bus 918 can be any suitable mechanism for communicating between two or more components 902, 904, 906, 910, and 914 in some embodiments.

Any other suitable components can be included in hardware 900 in accordance with some embodiments.

In some embodiments, at least some of the above described blocks of the processes of FIGS. 1, 4, and 7 can be executed or performed in any order or sequence not limited to the order and sequence shown in and described in connection with the figures. Also, some of the above blocks of FIGS. 1, 4, and 7 can be executed or performed substantially simultaneously where appropriate or in parallel to reduce latency and processing times. Additionally or alternatively, some of the above described blocks of the processes of FIGS. 1, 4, and 7 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as non-transitory forms of magnetic media (such as hard disks, floppy disks, and/or any other suitable magnetic media), non-transitory forms of optical media (such as compact discs, digital video discs, Blu-ray discs, and/or any other suitable optical media), non-transitory forms of semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Accordingly, methods, systems, and media for combining classifier scores of a hierarchical set of entities are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for generating classifier scores of a hierarchical set of entities, the method comprising:
determining a first plurality of scores associated with a media content item;
determining a second plurality of scores associated with a first ancestor entity of the media content item;
calculating an aggregate score of the media content item based on the first plurality of scores and the second plurality of scores;
determining whether the media content item is to be demoted based on the aggregate score; and
in response to determining that the media content item is to be demoted based on the aggregate score, causing the media content item to be demoted.

2. The method of claim 1, further comprising determining a third plurality of scores that is associated with a second ancestor entity of the media content item, wherein calculating the aggregate score of the media content item comprises calculating the aggregate score based on the first plurality of scores, the second plurality of scores, and the third plurality of scores.

3. The method of claim 1, wherein the media content item corresponds to a video item, and wherein the first ancestor entity corresponds to a playlist that includes the video item or a user channel that uploaded the video item.

4. The method of claim 1, wherein the first plurality of scores comprises a classifier score that indicates a quality of the media content item and a protection score that indicates an amount of protection from demotion provided to the media content item.

5. The method of claim 4, further comprising storing the first plurality of scores in a storage device, wherein the classifier score and the protection score are stored in different locations in the storage device.

6. The method of claim 1, further comprising:
receiving a search query;
generating a plurality of search results in response to the search query, wherein one of the plurality of search results corresponds to the media content item; and
causing at least a portion of the plurality of search results to be presented based on the demotion.

7. A system for generating classifier scores of a hierarchical set of entities, the system comprising:
a hardware processor that is configured to:
determining a first plurality of scores associated with a media content item;
determining a second plurality of scores associated with a first ancestor entity of the media content item;
calculating an aggregate score of the media content item based on the first plurality of scores and the second plurality of scores;
determining whether the media content item is to be demoted based on the aggregate score; and
in response to determining that the media content item is to be demoted based on the aggregate score, causing the media content item to be demoted.

8. The system of claim 7, wherein the hardware processor is further configured to determine a third plurality of scores that is associated with a second ancestor entity of the media content item, wherein calculating the aggregate score of the media content item comprises calculating the aggregate score based on the first plurality of scores, the second plurality of scores, and the third plurality of scores.

9. The system of claim 7, wherein the media content item corresponds to a video item, and wherein the first ancestor entity corresponds to a playlist that includes the video item or a user channel that uploaded the video item.

10. The system of claim 7, wherein the first plurality of scores comprises a classifier score that indicates a quality of the media content item and a protection score that indicates an amount of protection from demotion provided to the media content item.

11. The system of claim 10, wherein the hardware processor is further configured to store the first plurality of scores in a storage device, wherein the classifier score and the protection score are stored in different locations in the storage device.

12. The system of claim 7, wherein the hardware processor is further configured to:
receive a search query;
generate a plurality of search results in response to the search query, wherein one of the plurality of search results corresponds to the media content item; and
cause at least a portion of the plurality of search results to be presented based on the demotion.

13. A non-transitory computer-readable medium containing computer-executable instructions that, when executed by a processor, cause the processor to perform a method for generating classifier scores of a hierarchical set of entities, the method comprising:
determining a first plurality of scores associated with a media content item;
determining a second plurality of scores associated with a first ancestor entity of the media content item;
calculating an aggregate score of the media content item based on the first plurality of scores and the second plurality of scores;
determining whether the media content item is to be demoted based on the aggregate score; and
in response to determining that the media content item is to be demoted based on the aggregate score, causing the media content item to be demoted.

14. The non-transitory computer-readable medium of claim 13, wherein the method further comprises determining a third plurality of scores that is associated with a second ancestor entity of the media content item, wherein calculating the aggregate score of the media content item comprises calculating the aggregate score based on the first plurality of scores, the second plurality of scores, and the third plurality of scores.

15. The non-transitory computer-readable medium of claim 13, wherein the media content item corresponds to a video item, and wherein the first ancestor entity corresponds to a playlist that includes the video item or a user channel that uploaded the video item.

16. The non-transitory computer-readable medium of claim 13, wherein the first plurality of scores comprises a classifier score that indicates a quality of the media content item and a protection score that indicates an amount of protection from demotion provided to the media content item.

17. The non-transitory computer-readable medium of claim 16, wherein the method further comprises storing the first plurality of scores in a storage device, wherein the classifier score and the protection score are stored in different locations in the storage device.

18. The non-transitory computer-readable medium of claim 13, wherein the method further comprises:
receiving a search query;
generating a plurality of search results in response to the search query, wherein one of the plurality of search results corresponds to the media content item; and
causing at least a portion of the plurality of search results to be presented based on the demotion.
